(19) United States
(12) Patent Application Publication
(10) Pub. No.: US 2026/0361906 A1
(43) Pub. Date: Nov. 12, 2026

(54) WARPING LAYER FORMAT FOR IMPLICIT NEURAL REPRESENTATION

(71) Applicant: InterDigital CE Patent Holdings, SAS, Paris (FR)

(72) Inventors: Pierre Hellier, Thorigne-Fouillard (FR); Bharath Bhushan Damodaran, Vannes (FR); Anne Lambert, Saint-Aubin-d’Aubigné (FR); Francois Schnitzler, Saint Avé (FR)

(21) Appl. No.: 19/516,030

(22) PCT Filed: Sep. 2, 2024
(86) PCT No.: PCT/EP2024/074420

§ 371 Date: Mar. 3, 2026

(30) Foreign Application Priority Data
Sep. 6, 2023 (EP) 23306478.1

(51) Int. Cl. H04N 19/463; H04N 19/124; H04N 19/13; H04N 19/42; H04N 19/70

(52) U.S. Cl. CPC H04N 19/463; H04N 19/124; H04N 19/13; H04N 19/42; H04N 19/70

(57) ABSTRACT

A method comprising: obtaining a first portion of a first signal; obtaining an Implicit Neural Representation network learned for a second portion of a second signal; learning parameters of a neural network implementing a warping layer allowing mapping coordinates of the second signal on coordinates of the first signal, the learning comprising a minimization of a loss function representative of a difference between the first signal and warped coordinates of the first signal on which is applied the Implicit Neural Representation network; and, signaling at least a subset of the learned parameters into a data set and an index representing the Implicit Neural Representation network.

### 1. TECHNICAL FIELD

At least one of the present embodiments generally relates to a method and a device for encoding and decoding picture or video data based on an Implicit Neural Representation.

### 2. BACKGROUND

Implicit Neural Representation (INR) based compression techniques are relatively new compression techniques that can be applied to 2D picture, video, 3D scenes or objects. These techniques have a far lower computational complexity than end-to-end neural network based compression approaches.

An INR network is typically a neural network, composed of multiple neural layers, such as fully connected layers. Each neural layer can be described as a function that first multiplies an input signal by a tensor, adds a vector called the bias and then applies a nonlinear function on the resulting values. The shape (and other characteristics) of the tensor and the type of non-linear functions are called the architecture of the network.

The input signal may be modified by a transformation before being used as input for the neural network. This transformation can be a Fourier mapping, coordinate transformation, normalization etc.

An INR network is generally learned for an input signal and is used to reconstruct this input signal assuming that characteristics of the INR network are provided to a decoding unit in charge of reconstructing the input signal. The encoding of the INR network characteristics has a non-negligible cost in terms of bitrate.

It is well known that many signals are redundant. For instance, picture or video data comprise portions that are correlated at least partially in various parts of the signal. The use of these correlations is a base of picture or video compression technics.

It is highly probable that an INR network learned for a first signal would be usable (with some adaptations if necessary) to reconstruct a second signal correlated with the first signal. However, few solutions are proposed to reuse an INR network learned for a first signal for a second signal correlated with the first signal. This would allow reducing the signaling cost of INR networks characteristics.

It is desirable to propose solutions allowing to overcome the above issues. In particular, it is desirable to propose solutions allowing reducing the signaling cost of INR networks characteristics by reusing an INR network learned for a first signal for second signals correlated with the first signal.

### 3. BRIEF SUMMARY

In a first aspect, one or more of the present embodiments provide a method for encoding comprising:
obtaining a first portion of a first signal;
obtaining an Implicit Neural Representation network learned for a second portion of a second signal;
learning parameters of a neural network implementing a warping layer allowing mapping coordinates of the second signal on coordinates of the first signal, the learning comprising a minimization of a loss function representative of a difference between the first signal and warped coordinates of the first signal on which is applied the Implicit Neural Representation network; and,
signaling at least a subset of the learned parameters into a data set and an index representing the Implicit Neural Representation network.

In an embodiment, the first and the second signals are a same signal, and the second portion was encoded using the Implicit Neural Representation network.

In an embodiment, the warping layer is composed of a polynomial embedding resulting from a concatenation of a plurality of polynomial functions and a transformation layer implemented in the form of a multi-layer perceptron, the polynomial embedding and the transformation layer being defined by the learned parameters.

In an embodiment, the parameters are quantized and entropy encoded, the quantization and the entropy encoding of the parameters being taken into account in the minimization.

In an embodiment, responsive to a subset of the plurality of polynomial functions being signaled in the data set, a syntax element is signaled in the data set to indicate a use of the subset of the plurality and, indices of the polynomial functions of the subset of the plurality is signaled in the data set.

In a second aspect, one or more of the present embodiments provide a method for encoding comprising:
obtaining a first signal;
applying a joint learning phase allowing learning jointly parameters of an implicit neural representation network and parameters of a warping layer allowing mapping coordinates of a second signal on coordinates of the first signal, the joint learning phase comprising a minimization of a loss function representative of a difference between the first signal and warped coordinates of the first signal on which is applied the implicit neural representation network; and,
signaling the learned parameters of the implicit neural representation network and at least a subset of the learned parameters into a data set.

In a third aspect, one or more of the present embodiments provide a method for encoding comprising:
obtaining parameters of a neural network implementing a warping layer allowing mapping coordinates of the second portion of second signal on coordinates of a first portion of a first signal from a data set;
decoding an index representing an implicit neural representation network from the data set;
applying the warping layer with the obtained parameters on coordinates of samples of the first portion of the first signal to obtain warped coordinates; and,
applying the implicit neural representation network to the warped coordinates.

In an embodiment, the first and the second signals are a same signal, and the second portion was decoded using the Implicit Neural Representation network.

In an embodiment, the warping layer is composed of a polynomial embedding resulting from a concatenation of a plurality of polynomial functions and a transformation layer implemented in the form of a multi-layer perceptron, the polynomial embedding and the transformation layer being defined by the parameters.

In an embodiment, responsive to a subset of the plurality of polynomial functions being signaled in the data set, a syntax element is signaled in the data set to indicate a use of the subset of the plurality and, indices of the polynomial functions of the subset of the plurality is signaled in the data set.

In a fourth aspect, one or more of the present embodiments provide a device comprising electronic circuitry configured for:
obtaining a first portion of a first signal;
obtaining an Implicit Neural Representation network learned for a second portion of a second signal;
learning parameters of a neural network implementing a warping layer allowing mapping coordinates of the second signal on coordinates of the first signal, the learning comprising a minimization of a loss function representative of a difference between the first signal and warped coordinates of the first signal on which is applied the Implicit Neural Representation network; and,
signaling at least a subset of the learned parameters into a data set and an index representing the Implicit Neural Representation network.

In an embodiment, the first and the second signals are a same signal, and the second portion was encoded using the Implicit Neural Representation network.

In an embodiment, the warping layer is composed of a polynomial embedding resulting from a concatenation of a plurality of polynomial functions and a transformation layer implemented in the form of a multi-layer perceptron, the polynomial embedding and the transformation layer being defined by the learned parameters.

In an embodiment, the parameters are quantized and entropy encoded, the quantization and the entropy encoding of the parameters being taken into account in the minimization.

In an embodiment, responsive to a subset of the plurality of polynomial functions being signaled in the data set, a syntax element is signaled in the data set to indicate a use of the subset of the plurality and, indices of the polynomial functions of the subset of the plurality is signaled in the data set.

In a fifth aspect, one or more of the present embodiments provide a device comprising electronic circuitry configured for:
obtaining a first signal;
applying a joint learning phase allowing learning jointly parameters of an implicit neural representation network and parameters of a warping layer allowing mapping coordinates of a second signal on coordinates of the first signal, the joint learning phase comprising a minimization of a loss function representative of a difference between the first signal and warped coordinates of the first signal on which is applied the implicit neural representation network; and,
signaling the learned parameters of the implicit neural representation network and at least a subset of the learned parameters into a data set.

In a sixth aspect, one or more of the present embodiments provide a device comprising electronic circuitry configured for:
obtaining parameters of a neural network implementing a warping layer allowing mapping coordinates of a second portion of a second signal on coordinates of a first portion of a first signal from a data set;
decoding an index representing an implicit neural representation network from the data set;
applying the warping layer with the obtained parameters on coordinates of samples of the first portion of the first signal to obtain warped coordinates; and,
applying the implicit neural representation network to the warped coordinates.

In an embodiment, the first and the second signals are a same signal, and the second portion was decoded using the Implicit Neural Representation network.

In an embodiment, the warping layer is composed of a polynomial embedding resulting from a concatenation of a plurality of polynomial functions and a transformation layer implemented in the form of a multi-layer perceptron, the polynomial embedding and the transformation layer being defined by the parameters.

In an embodiment, responsive to a subset of the plurality of polynomial functions being signaled in the data set, a syntax element is signaled in the data set to indicate a use of the subset of the plurality and, indices of the polynomial functions of the subset of the plurality is signaled in the data set.

In a seventh aspect, one or more of the present embodiments provide a signal generated by the method of the first aspect or by the device of the fourth aspect.

In a eighth aspect, one or more of the present embodiments provide a non-transitory information storage medium storing program code instructions for implementing the method according to the first, second or third aspect.

In a ninth aspect, one or more of the present embodiments provide a computer program comprising program code instructions for implementing the method according to the first, second or third aspect.

### 4. BRIEF SUMMARY OF THE DRAWINGS

FIG. 1 illustrates an example of context in which various embodiments may be implemented;

FIG. 2A illustrates schematically an example of hardware architecture of a processing module able to implement an encoding module or a decoding module in which various aspects and embodiments are implemented;

FIG. 2B illustrates a block diagram of an example of a first system in which various aspects and embodiments are implemented;

FIG. 2C illustrates a block diagram of an example of a second system in which various aspects and embodiments are implemented;

FIG. 3 illustrates a simple neural network used for implicit neural representation;

FIG. 4A illustrates a typical process to encode a signal using an implicit neural representation;

FIG. 4B illustrates a typical process to decode a signal using an implicit neural representation;

FIG. 5 illustrates an example of partitioning undergone by a picture of pixels of an original video sequence;

FIG. 6 illustrates schematically a process to encode according to various embodiments; and,

FIG. 7 illustrates schematically a process to decode according to various embodiments;

### 5. DETAILED DESCRIPTION

In the following, various embodiments are applied to a 2D signal such as picture or video data. One can note that these various embodiments can also be applied identically to other types of signals such as 3D signals representing 3D scenes or objects.

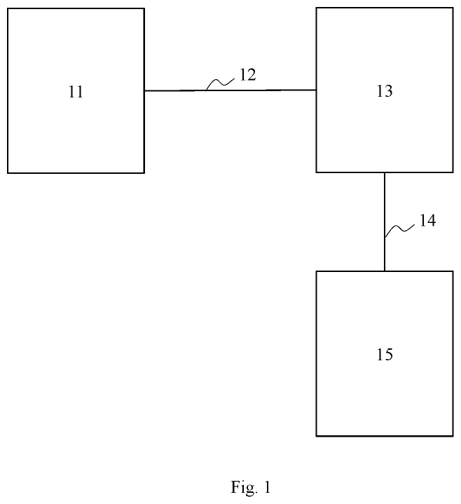

FIG. 1 describes an example of a context in which following embodiments can be implemented.

In FIG. 1, a system 11, that could be a camera, a storage device, a computer, a server or any device capable of delivering a video stream, transmits a video stream to a system 13 using a communication channel 12. The video stream is either encoded and transmitted by the system 11 or received and/or stored by the system 11 and then transmitted. The communication channel 12 is a wired (for example Internet or Ethernet) or a wireless (for example WiFi, 3G, 4G or 5G) network link.

The system 13, that could be for example a set top box, receives and decodes the video stream to generate a sequence of decoded pictures.

The obtained sequence of decoded pictures is then transmitted to a display system 15 using a communication channel 14, that could be a wired or wireless network. The display system 15 then displays said pictures.

In an embodiment, the system 13 is comprised in the display system 15. In that case, the system 13 and display system 15 are comprised in a TV, a computer, a tablet, a smartphone, a head-mounted display, etc.

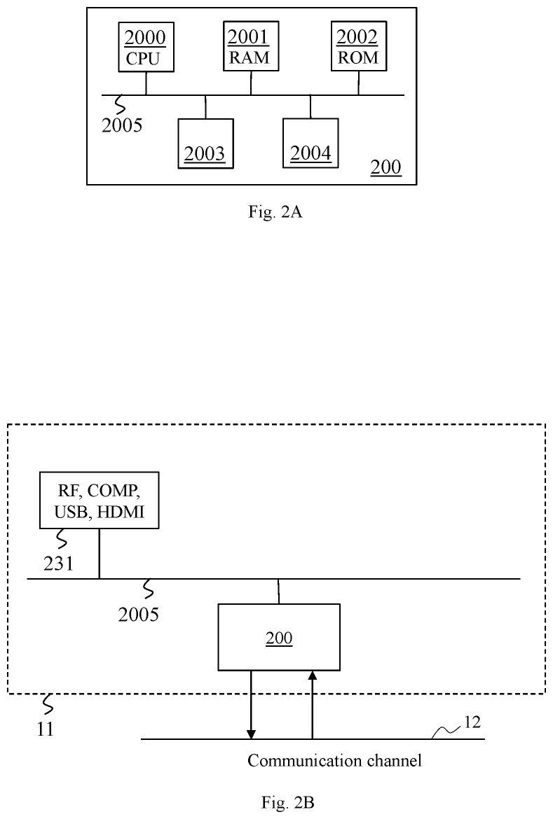

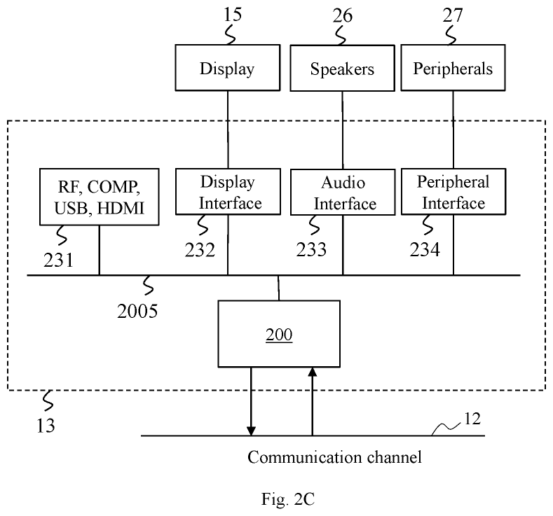

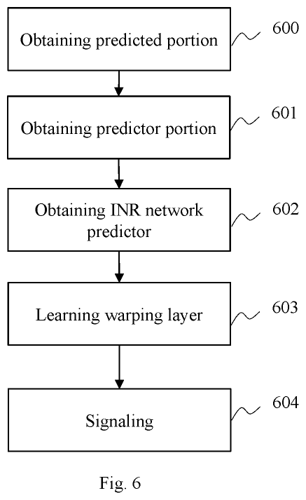

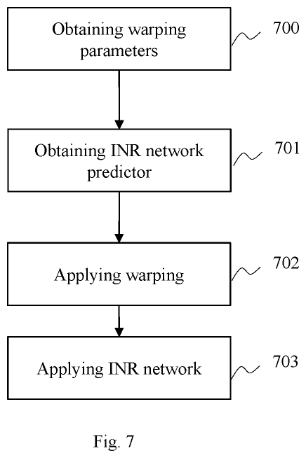

FIG. 2A illustrates schematically an example of hardware architecture of a processing module 200 able to implement an encoding module or a decoding module capable of implementing respectively a method for encoding of FIG. 6 and a method for decoding of FIG. 7. The encoding module is for example comprised in the system 11 when this apparatus is in charge of encoding the video stream. The decoding module is for example comprised in the system 13. The processing module 200 comprises, connected by a communication bus 2005: a processor or CPU (central processing unit) 2000 encompassing one or more microprocessors, general purpose computers, special purpose computers, and processors based on a multi-core architecture, as non-limiting examples; a random access memory (RAM) 2001; a read only memory (ROM) 2002; a storage unit 2003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 2004 for exchanging data with other modules, devices or equipment. The communication interface 2004 can include, but is not limited to, a transceiver configured to transmit and to receive data over a communication channel. The communication interface 2004 can include, but is not limited to, a modem or network card.

If the processing module 200 implements a decoding module, the communication interface 2004 enables for instance the processing module 200 to receive encoded video streams and to provide a sequence of decoded pictures. If the processing module 200 implements an encoding module, the communication interface 2004 enables for instance the processing module 200 to receive a sequence of original picture data to encode and to provide an encoded video stream.

The processor 2000 is capable of executing instructions loaded into the RAM 2001 from the ROM 2002, from an external memory (not shown), from a storage medium, or from a communication network. When the processing module 200 is powered up, the processor 2000 is capable of reading instructions from the RAM 2001 and executing them. These instructions form a computer program causing, for example, the implementation by the processor 2000 of a decoding method as described in relation with FIG. 7, an encoding method described in relation to FIG. 6, these methods comprising various aspects and embodiments described below in this document.

All or some of the algorithms and steps of the methods of FIGS. 6 and 7 may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

As can be seen, microprocessors, general purpose computers, special purpose computers, processors based or not on a multi-core architecture, DSP, microcontroller, FPGA and ASIC are electronic circuitry adapted to implement (i.e., configured for implementing) at least partially the methods of FIGS. 6 and 7.

FIG. 2C illustrates a block diagram of an example of the system 13 in which various aspects and embodiments are implemented. The system 13 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 13, singly or in combination, can be embodied in a single integrated circuit (IC), multiple ICs, and/or discrete components. For example, in at least one embodiment, the system 13 comprises one processing module 200 that implements a decoding module. In various embodiments, the system 13 is communicatively coupled to one or more other systems, or other electronic devices, via, for example, a communications bus or through dedicated input and/or output ports. In various embodiments, the system 13 is configured to implement one or more of the aspects described in this document.

The input to the processing module 200 can be provided through various input modules as indicated in block 231. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 2C, include composite video.

In various embodiments, the input modules of block 231 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 13 to other electronic devices across USB and/or HDMI connections. It is to be understood that various aspects of input processing, for example, Reed-Solomon error correction, can be implemented, for example, within a separate input processing IC or within the processing module 200 as necessary. Similarly, aspects of USB or HDMI interface processing can be implemented within separate interface ICs or within the processing module 200 as necessary. The demodulated, error corrected, and demultiplexed stream is provided to the processing module 200.

Various elements of system 13 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 13, the processing module 200 is interconnected to other elements of said system 13 by the bus 2005.

The communication interface 2004 of the processing module 200 allows the system 13 to communicate on the communication channel 12. As already mentioned above, the communication channel 12 can be implemented, for example, within a wired and/or a wireless medium.

Data is streamed, or otherwise provided, to the system 13, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 2004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 13 using the RF connection of the input block 231. As indicated above, various embodiments provide data in a non-streaming manner. Additionally, various embodiments use wireless networks other than Wi-Fi, for example a cellular network or a Bluetooth network.

The system 13 can provide an output signal to various output devices, including the display system 15, speakers 26, and other peripheral devices 27. The display system 15 of various embodiments includes one or more of, for example, a touchscreen display, an organic light-emitting diode (OLED) display, a curved display, and/or a foldable display. The display system 15 can be for a television, a tablet, a laptop, a cell phone (mobile phone), a head mounted display or other devices. The display system 15 can also be integrated with other components (for example, as in a smart phone), or separate (for example, an external monitor for a laptop). The other peripheral devices 27 include, in various examples of embodiments, one or more of a stand-alone digital video disc (or digital versatile disc) (DVR, for both terms), a disk player, a stereo system, and/or a lighting system. Various embodiments use one or more peripheral devices 27 that provide a function based on the output of the system 13. For example, a disk player performs the function of playing an output of the system 13.

In various embodiments, control signals are communicated between the system 13 and the display system 15, speakers 26, or other peripheral devices 27 using signaling such as AV.Link, Consumer Electronics Control (CEC), or other communications protocols that enable device-to-device control with or without user intervention. The output devices can be communicatively coupled to system 13 via dedicated connections through respective interfaces 232, 233, and 234. Alternatively, the output devices can be connected to system 13 using the communications channel 12 via the communications interface 2004 or a dedicated communication channel corresponding to the communication channel 14 in FIG. 2A via the communication interface 2004. The display system 15 and speakers 26 can be integrated in a single unit with the other components of system 13 in an electronic device such as, for example, a television. In various embodiments, the display interface 232 includes a display driver, such as, for example, a timing controller (T Con) chip.

The display system 15 and speaker 26 can alternatively be separate from one or more of the other components. In various embodiments in which the display system 15 and speakers 26 are external components, the output signal can be provided via dedicated output connections, including, for example, HDMI ports, USB ports, or COMP outputs.

FIG. 2B illustrates a block diagram of an example of the system 11 in which various aspects and embodiments are implemented. System 11 is very similar to system 13. The system 11 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 11, singly or in combination, can be embodied in a single integrated circuit (IC), multiple ICs, and/or discrete components. For example, in at least one embodiment, the system 11 comprises one processing module 200 that implements an encoding module. In various embodiments, the system 11 is communicatively coupled to one or more other systems, or other electronic devices, via, for example, a communications bus or through dedicated input and/or output ports. In various embodiments, the system 11 is configured to implement one or more of the aspects described in this document.

The input to the processing module 200 can be provided through various input modules as indicated in block 231 already described in relation to FIG. 2C.

Various elements of system 11 can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards. For example, in the system 11, the processing module 200 is interconnected to other elements of said system 11 by the bus 2005.

The communication interface 2004 of the processing module 200 allows the system 11 to communicate on the communication channel 12.

Data is streamed, or otherwise provided, to the system 11, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 2004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 11 using the RF connection of the input block 231.

As indicated above, various embodiments provide data in a non-streaming manner. Additionally, various embodiments use wireless networks other than Wi-Fi, for example a cellular network or a Bluetooth network.

The data provided to the system 11 can be provided in different format. In various embodiments, these data are raw data provided for example by a picture acquisition module connected to the system 11 or comprised in the system 11. In that case, the processing module take in charge the encoding of these data.

The system 11 can provide an output signal to various output devices capable of storing and/or decoding the output signal such as the system 13.

Various implementations involve decoding. “Decoding”, as used in this application, can encompass all or part of the processes performed, for example, on a received encoded video stream (i.e., received video data) in order to produce a final output suitable for display. In various embodiments, such processes include processes performed by a decoder of various implementations described in this application in relation to FIG. 7.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include processes performed by an encoder of various implementations described in this application in relation to FIG. 6.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some INR parameters. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the encoded video stream (i.e. encoded data). Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

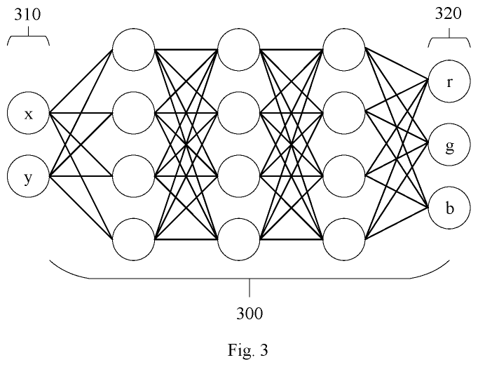

FIG. 3 illustrates a simple neural network used for implicit neural representation (INR). Such a neural network used for INR can be referred to as an INR network. For clarity, we use for illustration a 2D signal such as a picture, but, as already mentioned above, an INR can be used for signals of any dimension. An INR parameterizes a signal as a function (300) which takes coordinates (310) as input and outputs potentially approximated signal values (320) at these coordinates. When the signal processed by the INR is a picture, the inputs (310) can be sample coordinates (x,y) of picture samples and the INR outputs (320) are the picture sample values. Picture samples values can be original sample values of an original picture or residual values representative of a difference between predictor samples and the original samples. A picture sample can be a single component signal (such as a grey scale picture) or a multi-component signal comprising a plurality of components such as for example a RGB, YUV or YUV+d picture where d represents a depth component. In the video case, the output is similar, but the input can include a picture index t in addition to the sample coordinates. The INR can be used to reconstruct a signal by computing picture sample values for some or each sample coordinates (x,y).

An INR network is typically a neural network composed of multiple neural layers, such as fully connected layers. In FIG. 3, the network has four neural layers. Intermediate outputs are represented by circles. Each neural layer can be described as a function that first multiplies the input by a tensor, adds a vector called the bias and then applies a nonlinear function on the resulting values. In the present document, we may also refer to a neural layer simply as a layer. Tensors shapes (and other characteristics of the tensors) and non-linear functions types of the neural network defines an architecture of the neural network. In the following, tensor values and bias values are denoted by the term weights. The weights and, if applicable, the parameters of the non-linear functions, are called parameters θ of the neural network. The architecture and the parameters θ define a model. In the following we use ƒ_{θ} to denote an INR function parameterized by θ.

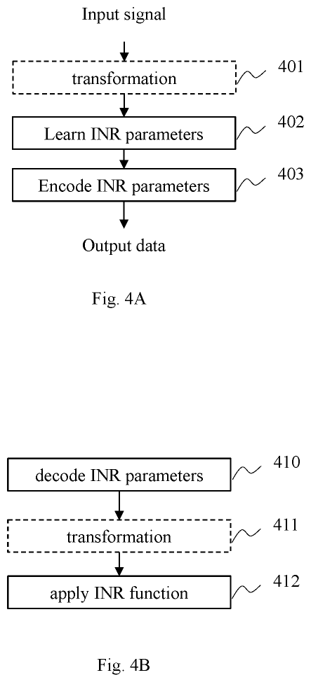

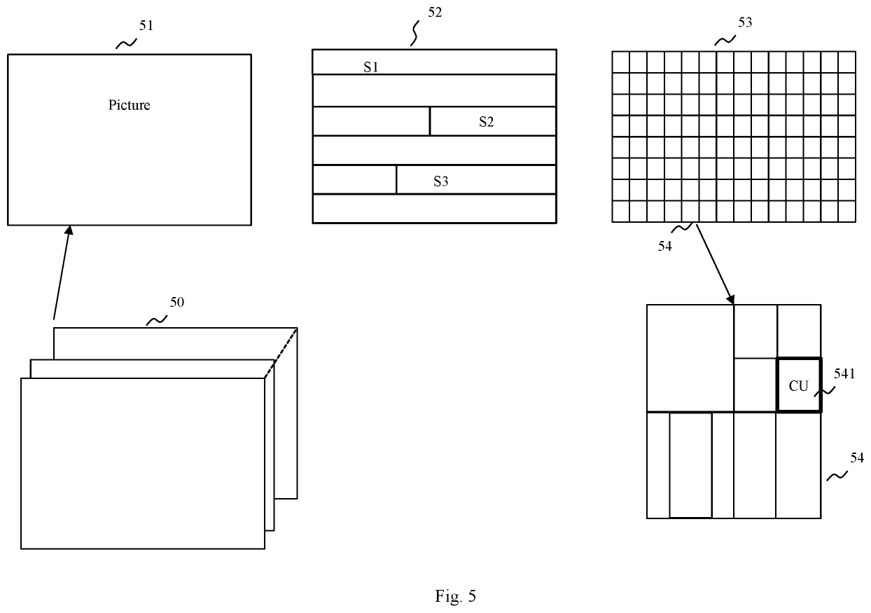

FIG. 4A illustrates a typical process to encode a signal using an INR.

The process of FIG. 4A is executed for example by the processing module 200 of the system 11.

In a step 402, the processing module 200 obtains an input signal and applies a learning phase during which the INR parameters θ (or a subset of them) of the INR network allowing reconstructing the input signal from the samples coordinates are learned. In an embodiment, the INR parameters θ are learned by minimizing a loss function such as for example, the loss function of equation eq. 1 below:

Loss=D(I,ƒ_{θ})+βR(θ) (eq. 1)

where D is a distortion which represents a difference between a reconstructed version of the signal obtained by applying the INR function ƒ_{θ} to input coordinates and the original signal I, R is a bitrate of the encoded INR parameters θ and β is a trade-off parameter representing a trade-off between the distortion D and the bitrate R. D could be any distortion measure, such as mean squared error as in equation eq. 2.

$${D}_{MSE} = \frac{1}{MN} {\sum }_{x , y} {( I ( x , y ) - {f}_{θ} ( x , y ) )}^{2} \qquad ( eq . 2 )$$

M and N are a width and a height of a picture when the signal is a picture. Other metrics such as LPIPS (Learned Perceptual Image Patch Similarity) can also be used in this case. The optimization of the INR parameters (or weights) θ is typically performed by a machine learning approach such as a batch gradient descent method.

In a step 403, the processing module 200 encodes the INR parameters θ (or a subset of them) in an output bitstream (i.e., in output data). When the signal is a picture, the processing module 200 also adds information representative of the picture such as the width and the height of the picture.

In some variants of the process of FIG. 4A, the input coordinates (x,y) may be modified by the processing module 200 in an optional step 401 by a transformation before being used as input for the INR. This transformation can be a Fourier mapping, a coordinate transformation, a normalization etc. Document Tancik, M. S.-K. (2020). Fourier features let networks learn high frequency functions in low dimensional domains. Advances in Neural Information Processing Systems, (pp. 7537-7547) showed that a mapping into Fourier features (i.e., a Fourier mapping) enables a Multi-layer Perceptron (MLP) learn high-frequency components of an input signal. Otherwise, the MLP has a spectral bias and is unable to learn the high frequencies of the input signal, which degrades considerably a visual quality when reconstructing the encoded signal.

Technically, the Fourier mapping of an input coordinate v=(x, y) is defined as:

$$γ ( v ) = {[ {a}_{1} cos ( 2 π {b}_{1}^{T} v ) , {a}_{1} sin ( 2 π {b}_{1}^{T} v ) , ... , {a}_{m} cos ( 2 π {b}_{m}^{T} v ) , {a}_{m} sin ( 2 π {b}_{m}^{T} v ) ]}^{T}$$

Hence, the mapping depends on the coefficients aᵢ, bᵢ where the coefficients bᵢ are the Fourier basis frequencies when the mapping is seen as a Fourier approximation of a kernel function. In some implementations, the coefficients aᵢ, bᵢ are predefined.

FIG. 4B illustrates a typical process to decode data using INR.

The process of FIG. 4B is executed for example by the processing module 200 of the system 13.

In a step 410, the processing module 200 obtains input data, for instance, corresponding to the output data generated by the processing module 200 of the system 11 when applying the method of FIG. 4A. The input data comprises encoded INR parameters θ. During step 410, the processing module 200 decodes the INR parameters θ from the input data and regenerates the INR network applying the INR function ƒ_{θ}. When the signal is a picture, the processing module 200 also decodes the information representative of the picture.

In a step 412, the processing module 200 applies the regenerated INR network (i.e., the processing module 200 applies the INR function ƒ_{θ}) to samples coordinates to generate a reconstructed version of the input signal obtained by the system 11 in step 402 (or in the optional step 401). If the input signal is a picture, the processing module 200 applies the regenerated INR network to at least a sub-part of the samples coordinates (x,y) of the picture. As an example, for a 256×256 samples picture, these coordinates could be all pairs (x,y) for all x∈{0, 1, . . . , 255} and y∈{0, 1, . . . , 255}. Other choices are possible, for example to generate an up-sampled, down-sampled or extended version of the input picture.

Of course, if a transformation, such as a Fourier mapping based on the coefficients aᵢ, bᵢ, was applied during the encoding process (step 401) to the input coordinates (x,y), the same transformation is applied by the processing module 200 in an optional step 411 to the sample coordinates (x,y) and step 412 is applied to the transformed sample coordinates.

Using one INR network globally for a whole signal makes learning difficult, as all parameters contribute to all values and lead to a large network as it must encode all details of the signal. A solution to address this issue is to divide the signal in partitions and to define a local INR network for each partition. When the signal is a picture, the partition of a picture could be a slice, a tile, a coding unit, etc.

FIG. 5 illustrates an example of partitioning undergone by a picture of pixels 51 of an original video sequence 20.

A picture is divided into a plurality of coding entities. First, as represented by reference 53 in FIG. 5, a picture is divided in a grid of blocks called coding tree units (CTU). A CTU consists for example of an V×V block of luminance samples together with two corresponding blocks of chrominance samples. Vis generally a power of two. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. Above the concept of tiles and bricks, another encoding entity, called slice, exists, that can contain at least one tile of a picture or at least one brick of a tile.

In the example in FIG. 5, as represented by reference 52, the picture 51 is divided into three slices S1, S2 and S3 of the raster-scan slice mode, each comprising a plurality of tiles (not represented), each tile comprising only one brick.

As represented by reference 54 in FIG. 5, a CTU may be partitioned into the form of a hierarchical tree of one or more sub-blocks called coding units (CU). The CTU is the root (i.e., the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e., child nodes) if it is further partitioned.

In the example of FIG. 5, the CTU 54 is first partitioned in “4” square CU using a quadtree type partitioning. The upper left CU is a leaf of the hierarchical tree since it is not further partitioned, i.e., it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned so as to optimize a criterion such as a criterion of homogeneity of samples in a partition (based on characteristics of the CUS, such as pixel mean, variance, texture and/or any other statistics of the signal within a considered CUs) or compression efficiency of the CTU criterion.

In the present application, the term “block” or “picture block” can be used to refer to any one of a CTU and a CU.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably. Usually, but not necessarily, the term “reconstructed” is used at the encoder side while “decoded” is used at the decoder side.

In the following, it is considered that the processing module 200 of the system 11 obtains a picture divided in coding units (CU) and that the encoding process of FIG. 4 is applied to some coding units independently but an INR network is obtained for each CU. To do so, instead of learning INR parameters θ (i.e., instead of learning an INR function ƒ_{θ}) adapted to each CU, in the following embodiments, some CU use an INR network, called INR network predictor in the following, previously learned on another CU. In the following, a CU using an INR network predictor is called a predicted CU and an INR network predicted from an INR network predictor is called predicted INR network of the predicted CU.

For a predicted CU, a warping layer is applied to account the geometrical transformation between the CU for which was learned the INR network predictor, called predictor CU, and the predicted CU. The geometrical transformations comprise for instance a translation, a rotation, a skew, etc. A warping layer allows mapping the predictor CU on the predicted CU. Therefore, the predicted INR network can be viewed as a combination of the INR network predictor with a warping layer.

The warping layer is implemented as a neural network. Let us define a warping layer w, parametrized as a neural network, as follows:

$$w ( \begin{matrix}x \\ y\end{matrix} ) = ( \begin{matrix}{x}^{′} \\ {y}^{′}\end{matrix} )$$

where

$$( \begin{matrix}x \\ y\end{matrix} )$$

denotes spatial coordinates of a pixel.

The warping layer w is composed of the following functions:

$$w ( \begin{matrix}x \\ y\end{matrix} ) = t ∘ {P}_{d} ( \begin{matrix}x \\ y\end{matrix} )$$

P_{d} is a polynomial embedding parametrized by a parameter d, whose goal is to express polynomial functions of input coordinates. More precisely, let us define the following function:

$${E}_{k} ( \begin{matrix}x \\ y\end{matrix} ) = {( {\{ {x}^{k - i} {y}^{i} \}}_{i = 0}^{i = k} )}^{T} = {( {x}^{k} , {x}^{k - 1} y , ... , {xy}^{k - 1} , {y}^{k} )}^{T}$$

Then, the polynomial embedding of dimension d is the concatenation of all functions Eₖ, for k≤d, or the concatenation of a subset of functions, without loss of generality.

Mathematically,

$${P}_{d} ( \begin{matrix}x \\ y\end{matrix} ) = \{ {E}_{0} ( \begin{matrix}x \\ y\end{matrix} ) , {E}_{1} ( \begin{matrix}x \\ y\end{matrix} ) , ... , {E}_{d} ( \begin{matrix}x \\ y\end{matrix} ) \}$$

Following the polynomial embedding, a transformation layer t is implemented in the form of a multi-layer perceptron of n layers, each of a given dimension H followed by a linear or non-linear activation function chosen in a library of activation functions (Identity, Sigmoid, hyperbolic tangent, ReLU, Leaky ReLU, ELU). In the following, without loss a generality, we assume that there is a correspondence table for the library of possible activations functions wherein each activation function is identified by an index. Similarly to the INR network, each layer of the multi-layer perceptron implementing the transformation network t can be described as a function that first multiplies an input by a tensor, adds a vector called the bias and then applies a linear or non-linear activation function on the resulting values. The transformation t can therefore be characterized by a number of layers of the multi-layer perceptron, and, for each layer, a shape (dimension, etc) of the tensor implementing the layer, a type of activation function and the weights of the tensor.

In an embodiment, the predictor CU and the predicted CU are associated using a means to identify correlations. The means to identify correlations is for example a CU level motion estimation/compensation process. In that case, for example, INR networks had been learned for CU of a reference picture and the learned CU are used as INR network predictors for CU of a current picture temporally predicted from the reference picture.

Even if described based on CU, the following embodiments are not restricted to CU and is adapted to other portions of signals such as a complete picture (in that case, the INR network predictor had been trained on another picture), patches, superpixels, areas, slices, tiles, non-square or rectangular blocks or any connected or disconnected set of pixels. In that case a predictor CU becomes a predictor portion and a predicted CU becomes a predicted portion.

FIG. 6 illustrates schematically a process to encode a CU according to various embodiments.

The process of FIG. 6 is executed for example by the processing module 200 of the system 11.

In a step 600, the processing module 200 obtains a predicted CU of a current picture.

In a step 601, the processing module 200 obtains a predictor CU for the predicted CU.

In a step 602, the processing module 200 obtains an INR network associated with the predictor CU. This INR network becomes an INR network predictor for the predicted CU.

In a step 603, the processing module learns warping parameters of the warping layer to be applied to the coordinates (x,y) of the predicted CU. The warping layer allows mapping the coordinates of the predictor CU on the coordinates of the predicted CU.

In an embodiment, a warping layer w adapted to the predicted CU is estimated via a minimization of a loss function represented below by equation eq. 3:

$$\hat{w} = arg {min}_{w} {\sum }_{x , y} {( {I}_{1} ( x , y ) - {f}_{θ} ( w ( x , y ) ) )}^{2} \qquad ( eq . 3 )$$

where I₁(x, y) represents the samples values of the predicted CU I₁, ƒ_{θ} is the INR network predictor applied to warped coordinates (x,y) of the predicted CU. It amounts at replacing the loss function of equation Eq. 1 by the loss function of equation eq. 3 in step 402 of the process of FIG. 4.

Once the warping parameters of the warping layer are learned, the processing module 200 signals these coordinates into a bistream (i.e., in picture or video data). The warping parameters comprise: the depth of the polynomial embedding d; the characteristics of the transformation network t, including: the number of layers and for each layer, the shape of the layer, the type of activation function used, and the weights of the tensor.

In an embodiment, the depth of the polynomial embedding d is encoded with “8” bits and each characteristic of the transformation network t is encoded on 8 bits. In an embodiment the weights of the tensors are quantized and entropy encoded.

In a variant, when the quantization process and the entropy encoding is known, the loss function, for instance the loss function of equation eq. 3, takes into account the quantization and the entropy encoding of the weights of the tensors.

In a variant, responsive to only a subset of all functions Eₖ, k<d of the polynomial embedding P_{d} is used, a Boolean value is signaled in the bitstream to indicate the use of the subset and, the indices of the used functions of the subset are signaled and transmitted in the bitstream.

In a variant, in step 402 of the process of FIG. 4, the loss function of equation eq. 1 is replaced by the following loss function:

$$Loss = D ( {I}_{1} , {f}_{θ} , w ) + β R ( θ , w ) \qquad ( eq . 4 )$$

$$where$$

$$D ( {I}_{1} , {f}_{θ} , w ) = \frac{1}{MN} {\sum }_{x , y} {( {I}_{1} ( x , y ) - {f}_{θ} ( w ( x , y ) ) )}^{2} \qquad ( eq . 5 )$$

and R(θ, w) is a bitrate of the encoded INR parameters θ and warping parameters of the warping layer w. Here only the warping parameters are learned, the function ƒ_{θ} (and the parameters θ) being known since provided by the INR network predictor. In an embodiment, the INR parameters θ are encoded in the form of an index allowing identifying the INR network predictor. The index is for example a motion vector pointing on the predictor CU.

In a variant, the processing module 200 skips step 601 and directly obtains an INR network predictor for the current CU. The INR network predictor is for example selected randomly in a set of predefined INR network predictors. In that case, the INR parameters θ are encoded in the form of an index of the selected INR network predictor in the set of predefined INR network predictors.

In a variant, the processing module 200 skips step 601 and determines the INR network predictor in a set of predefined INR network predictors during step 603. For instance, warping parameters are learned for each INR network predictor of the set of predefined INR network predictors and the one minimizing the signaling cost of the warping parameters is selected. The set of predefined INR network predictors could have been determined using CU of a large set of training sequences. Again, in that case, the INR parameters θ are encoded in the form of an index of the selected INR network predictor in the set of predefined INR network predictors.

In a variant, the processing module 200 skips step 601 and 602 and determines jointly the INR network ƒ_{θ} and the warping layer w during step 603. This variant is particularly useful when the INR network ƒ_{θ} is not known but the INR network ƒ_{θ} is shared for several CUs. This variant consists therefore in determining a single INR network ƒ_{θ} for a plurality of CUs but a warping layer w for each CU of the plurality. In that case, the loss function of equation eq. 3 is replaced by the following loss function:

$$\hat{θ} , \hat{w} = arg {min}_{θ , w} {\sum }_{x , y} {( {I}_{1} ( x , y ) - {f}_{θ} ( w ( x , y ) ) )}^{2} \qquad ( eq . 6 )$$

where I₁(x, y) represents the samples values of the predicted CU I₁, ƒ_{θ} is the INR network predictor applied to warped coordinates (x,y) of the predicted CU. In that case, the INR parameters θ are encoded along with the warping parameters of the warping layer w.

In a variant, in step 402 of the process of FIG. 4, the loss function of Equation 1 is replaced by the following loss function to learn jointly the INR network ƒ_{θ} and the warping layer w:

Loss=D(I₁,ƒ_{θ},w)+βR(θ,w) (eq. 7)

where

$$D ( {I}_{1} , {f}_{θ} , w ) = \frac{1}{MN} {\sum }_{x , y} {( {I}_{1} ( x , y ) - {f}_{θ} ( w ( x , y ) ) )}^{2} \qquad ( eq . 8 )$$

and R(θ, w) is a bitrate of the encoded INR parameters θ and of the warping parameters.

Learning jointly the INR network ƒ_{θ} and the warping layer w may allow compensating eventual defects of a transformation layer such as a Fourier mapping in the encoding and decoding process. Indeed, in some implementations, the Fourier mapping is done with pre-determined frequencies that are not well adapted to the signal to overfit. In that case, the warping layer may allow to optimize afterward the Fourier mapping.

In a variant, parameters of a Fourier mapping γ, the INR parameters θ and the warping layer w are learned jointly. In step 402 of the process of FIG. 4, the loss function of equation eq. 1 is replaced by the following loss function to learn jointly the INR network ƒ_{θ}, the warping layer w and the Fourier mapping γ:

Loss=D(I₁,ƒ_{θ}·γ,w)+βR(θ,w,γ) (Eq. 9)

where

$$D ( {I}_{1} , {f}_{θ} ∘ γ , w ) = \frac{1}{MN} {\sum }_{x , y} {( {I}_{1} ( x , y ) - {f}_{θ} ∘ γ ( w ( x , y ) ) )}^{2} \qquad ( eq . 10 )$$

and R(θ, w, γ) is a bitrate of the encoded INR parameters θ, warping parameters of the warping layer w and the parameters of the Fourier mapping γ.

FIG. 7 illustrates schematically a process to decode a picture according to various embodiments.

The process of FIG. 7 is executed for example by the processing module 200 of the system 13 on video data representing a predicted CU produced by the method of FIG. 6.

In a step 700, the processing module 200 obtains (i.e., decodes) warping parameters of the warping layer w from the video data.

In a step 701, the processing module 200 decodes an information representative of an INR network predictor from the video data. As seen above in relation with FIG. 6, this information allows the processing module 200 reconstructing the INR network to be applied to the predicted CU.

In a step 702, the processing module 200 applies the warping layer with the decoded warping parameters to the coordinates of samples of the predicted block to obtain warped coordinates.

In a step 703, the processing module 200 applies the INR network predictor to the warped coordinates of the predicted block.

In an embodiment, when the warping parameters, the INR parameters (and eventually the Fourier mapping parameters) were quantized and entropy encoded, their decoding comprises an inverse quantization and an entropy decoding.

Again, if a transformation, such as a Fourier mapping based on the coefficients aᵢ, bᵢ, was applied during the encoding process to the input coordinates (x,y), the same transformation is applied by the processing module 200 to the sample coordinates (x,y) and step 703 is applied to the transformed sample coordinates.

We described above a number of embodiments. Features of these embodiments can be provided alone or in any combination. Further, embodiments can include one or more of the following features, devices, or aspects, alone or in any combination, across various claim categories and types:
A bitstream or signal or video data that includes information representative of one or more of the described INR parameters, INR architecture or of a partitioning of a picture, or variations thereof.
Creating and/or transmitting and/or receiving and/or decoding a bitstream or signal that includes information representative of one or more of the described INR parameters, INR architecture or of a partitioning of a picture, or variations thereof.
A TV, set-top box, cell phone, tablet, or other electronic device that performs at least one of the embodiments described.
A TV, set-top box, cell phone, tablet, or other electronic device that performs at least one of the embodiments described, and that displays (e.g. using a monitor, screen, or other type of display) a resulting picture.
A TV, set-top box, cell phone, tablet, or other electronic device that tunes (e.g. using a tuner) a channel to receive a signal including an encoded video stream, and performs at least one of the embodiments described.
A TV, set-top box, cell phone, tablet, or other electronic device that receives (e.g. using an antenna) a signal over the air that includes an encoded video stream, and performs at least one of the embodiments described.
A server, camera, cell phone, tablet or other electronic device that transmits (e.g. using an antenna) a signal over the air that includes an encoded video stream, and performs at least one of the embodiments described.
A server, camera, cell phone, tablet or other electronic device that tunes (e.g. using a tuner) a channel to transmit a signal including an encoded video stream, and performs at least one of the embodiments described.

1-23. (canceled)

24. A method comprising:
obtaining a first portion of a first signal representing first image data;
obtaining an implicit neural representation network learned for a second portion of a second signal representing second image data;
learning parameters of a neural network implementing a warping layer allowing mapping coordinates of the second portion of the second signal on coordinates of the first portion of the first signal, the learning comprising a minimization of a loss function representative of a difference between the first portion of the first signal and warped coordinates of the first portion of the first signal on which is applied the implicit neural representation network; and
signaling at least a subset of the learned parameters and an index representing the implicit neural representation network into a bitstream.

25. The method of claim 24, wherein the first and the second signals are a same signal, and wherein the second portion was encoded using the implicit neural representation network.

26. The method of claim 24, wherein the warping layer is composed of a polynomial embedding resulting from a concatenation of a plurality of polynomial functions and a transformation layer implemented in the form of a multi-layer perceptron, and wherein the polynomial embedding and the transformation layer are defined by the learned parameters.

27. The method of claim 26, wherein the learned parameters are quantized and entropy encoded, and wherein the quantization and the entropy encoding of the parameters are taken into account in the minimization.

28. The method according to claim 26, wherein, responsive to a subset of the plurality of polynomial functions being signaled in the bitstream, a syntax element is signaled in the bitstream to indicate use of the subset, and indices of one or more polynomial functions of the subset are signaled in the bitstream.

29. The method of claim 24, wherein:
the implicit neural representation network and the neural network implementing the warping layer are learned jointly.

30. A method comprising:
obtaining parameters of a neural network implementing a warping layer allowing mapping coordinates of a second portion of a second signal representing second image data on coordinates of a first portion of a first signal representing first image data from a bitstream;
decoding an index representing an implicit neural representation network from the bitstream;
applying the warping layer with the obtained parameters on coordinates of samples of the first portion of the first signal to obtain warped coordinates; and
applying the implicit neural representation network to the warped coordinates.

31. The method of claim 30, wherein the first and the second signals are a same signal, and wherein the second portion was decoded using the implicit neural representation network.

32. The method of claim 30, wherein the warping layer is composed of a polynomial embedding resulting from a concatenation of a plurality of polynomial functions and a transformation layer implemented in the form of a multi-layer perceptron, and wherein the polynomial embedding and the transformation layer are defined by the parameters.

33. The method according to claim 32, wherein, responsive to a subset of the plurality of polynomial functions being signaled in the bitstream, a syntax element is signaled in the bitstream to indicate use of the subset, and indices of one or more polynomial functions of the subset are signaled in the bitstream.

34. A device comprising electronic circuitry configured for:
obtaining a first portion of a first signal representing first image data;
obtaining an implicit neural representation network learned for a second portion of a second signal representing second image data;
learning parameters of a neural network implementing a warping layer allowing mapping coordinates of the second portion of the second signal on coordinates of the first portion of the first signal, the learning comprising a minimization of a loss function representative of a difference between the first portion of the first signal and warped coordinates of the first portion of the first signal on which is applied the implicit neural representation network; and
signaling at least a subset of the learned parameters and an index representing the implicit neural representation network into a bitstream.

35. The device of claim 34, wherein the first and the second signals are a same signal, and wherein the second portion was encoded using the implicit neural representation network.

36. The device of claim 34, wherein the warping layer is composed of a polynomial embedding resulting from a concatenation of a plurality of polynomial functions and a transformation layer implemented in the form of a multi-layer perceptron, and wherein the polynomial embedding and the transformation layer are defined by the learned parameters.

37. The device of claim 36, wherein the learned parameters are quantized and entropy encoded, and wherein the quantization and the entropy encoding of the parameters are taken into account in the minimization.

38. The device according to claim 37, wherein, responsive to a subset of the plurality of polynomial functions being signaled in the bitstream, a syntax element is signaled in the bitstream to indicate use of the subset, and indices of one or more polynomial functions of the subset are signaled in the bitstream.

39. The device of claim 34, wherein the implicit neural representation network and the neural network implementing the warping layer are learned jointly.

40. A device comprising electronic circuitry configured for:
obtaining parameters of a neural network implementing a warping layer allowing mapping coordinates of a second portion of a second signal representing second image data on coordinates of a first portion of a first signal representing first image data from a bitstream;
decoding an index representing an implicit neural representation network from the bitstream;
applying the warping layer with the obtained parameters on coordinates of samples of the first portion of the first signal to obtain warped coordinates; and
applying the implicit neural representation network to the warped coordinates.

41. The device of claim 40, wherein the first and the second signals are a same signal, and wherein the second portion was decoded using the implicit neural representation network.

42. The device of claim 40, wherein the warping layer is composed of a polynomial embedding resulting from a concatenation of a plurality of polynomial functions and a transformation layer implemented in the form of a multi-layer perceptron, and wherein the polynomial embedding and the transformation layer are defined by the parameters.

43. The device according to claim 42, wherein, responsive to a subset of the plurality of polynomial functions being signaled in the bitstream, a syntax element is signaled in the bitstream to indicate use of the subset, and indices of one or more polynomial functions of the subset are signaled in the bitstream.
